(19) United States
(12) Patent Application Publication
(10) Pub. No.: US 2005/0008035 A1
(43) Pub. Date: Jan. 13, 2005

(54) Method and device for retransmission of transmitted units

(76) Inventors: Carl Eklund, Helsinki (FI); Juha Salokannel, Kangasala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/494,582

(22) PCT Filed: Nov. 12, 2001
(86) PCT No.: PCT/EP01/13063

(51) Int. Cl. H04J 3/24

(52) U.S. Cl. 370/473; 370/476

(57) ABSTRACT

The invention relates to a method for retransmitting a transmission unit (12) via an air interface in a wireless access system employing fragmentation for transmissions, wherein the available transmission capacity on said air interface is variable, and wherein said transmission unit (12) was transmitted a first time together with fragmentation information. In order to enable such a retransmission, it is proposed that the transmission unit (12) is retransmitted after a refragmentation with information FC, FSN on this refragmentation and with at least some of the fragmentation information FC′, FSN′, TSN that was transmitted before with said transmission unit (12) in the first transmission. The invention equally relates to a corresponding wireless access system and to a corresponding transmitting unit for such a wireless access system.

### FIELD OF THE INVENTION

The invention relates to a method for retransmitting a transmission unit via an air interface in a wireless access system employing fragmentation for transmissions. The transmission capacity on the air interface is assumed to be variable in this system and a transmission unit that is to be retransmitted was transmitted a first time together with fragmentation information. The invention equally relates to a transmitting unit for such a wireless access system and to a corresponding wireless access system.

### BACKGROUND OF THE INVENTION

A wireless access system employing fragmentation and an adaptive modulation for transmitting signals is specified e.g. in the IEEE draft P802.16/DS-2001: “Local and Metropolitan Area Networks—Part 16: Standard Air Interface for Fixed Broadband Wireless Access Systems”, which is incorporated by reference herein. The standard specifies the air interface, including the medium access control layer (MAC) and a physical layer (PHY), of fixed point-to-multipoint broadband wireless access systems providing multiple services. In this system, MAC SDUs (service data units) that are to be transmitted from a transmitting unit to a receiving unit are fragmented for transmission into MAC PDUs (protocol data units). The defined system operates at frequencies of 10-66 GHz.

An amendment 802.16a of this standard is currently under development for systems operating between 2 GHz and 11 GHz. The amendment introduces new functionality for this frequency range, such as an Automatic Repeat Request (ARQ). With ARQ, a receiving unit may request a retransmission of transmission units that were for instance lost during transmission over the air interface by transmitting an ARQ feedback to the transmitting unit. The proposed algorithm for repeating a transmission is a selective repeat algorithm, i.e. only those fragments are retransmitted which are not received satisfactorily at the receiving unit after the first transmission. A selective repeat ARQ mechanism will often require a packet reordering.

Variations of the environmental conditions on the transmission path are compensated in a system according to the 802.16a standard with a variation of the modulation and with a forward error correction (FEC). The transmission capacity of the radio link can thus vary significantly between the time of a first transmission and the time of a retransmission. In case the environmental conditions deteriorate, it might be necessary for the retransmission to refragment the fragments that are to be retransmitted into shorter MAC PDUs. The conventional method of sequence numbering employed for a single fragmentation is not suited for handling such a refragmentation.

The currently proposed solution for refragmentation in the 802.16a system mandates that the MAC SDUs are chopped into fixed sized ARQ blocks. Only the last block will be a shortened block if the MAC SDU size is not an exact multiple of the ARQ block size. Each ARQ block is identified by an ARQ block number assigned to it by the MAC. A set of ARQ blocks that are to be transmitted or retransmitted are included in a MAC PDU. The block number of the first block is carried in a subheader in each MAC PDU, or in each packing element in case a MAC PDU carries packed MAC SDUs or MAC SDU fragments. The MAC level fragmentation function is restricted to fragment MAC SDUs on ARQ block boundaries.

The restriction put on the fragmentation protocol in the current proposal, however, is incompatible with the fragmentation procedure specified in the 802.16 standard, since it does not allow a variable fragmentation. The block numbering scheme also limits the possibilities of using implementations designed for a 802.16 system also for 802.16a systems.

### SUMMARY OF THE INVENTION

It is an object of the invention to enable a retransmission of a transmission unit in a wireless access system which has a variable available transmission capacity and which employs fragmentation for transmissions. It is moreover an object of the invention to enable a retransmission of transmission units which is compatible with the fragmentation protocol defined in the IEEE standard 802.16.

The objects of the invention are reached with a method for retransmitting a transmission unit via an air interface in a wireless access system employing fragmentation for transmissions. The available transmission capacity on the air interface is variable, and the transmission unit is transmitted a first time together with fragmentation information. It is proposed that the transmission unit is retransmitted after a refragmentation with information on this refragmentation and with at least some of said fragmentation information that was transmitted before with said transmission unit in said first transmission.

The objects of the invention are equally reached with a transmitting unit for a wireless access system which transmitting unit comprises means for realizing the proposed method. Finally, the objects of the invention are reached with a wireless access system comprising such a transmitting unit and a receiving unit for receiving transmitted transmission units and for requesting a retransmission of a transmission unit if necessary.

The invention proceeds from the idea that in case a transmission unit which has to be retransmitted comprises on the one hand fragmentation information of the original transmission unit and on the other hand fragmentation information describing the fragmentation employed for retransmission, an easy refragmentation mechanism is enabled which allows to rebuild and reorder the fragments as required for a retransmission. In particular, the fragments of a transmission unit resulting in refragmentation can be assigned their own fragmentation information as any transmission unit which is transmitted for the first time.

It is to be understood that the proposed method does not require that each transmission unit that is to be retransmitted is refragmented into new fragments. For example, if the available transmission capacity is the same for a first transmission and for a repeated transmissions of a transmission unit, the transmission unit may be transmitted again without the necessity for a different fragmentation than before.

It is an advantage of the invention that it provides a simple solution for retransmitting transmission units.

It is moreover an advantage of the invention that it provides a transmission unit numbering scheme that allows the reuse of the 802.16 fragmentation protocol. The invention further allows implementations more easily to address both, the 802.16 standard and the amendment 802.16a.

Preferred embodiments of the invention become apparent from the subclaims.

Since traffic is usually to be transmitted bi-directionally, and since in most of the remaining cases at least a feedback is to be enabled after a transmission, the transmitting unit is advantageously part of a first transceiver device. Accordingly, the transmitting unit advantageously transmits the transmission units to a receiving unit which is part of a second transceiver device.

Preferably, a retransmission of a transmission unit is carried out upon request by a receiving unit, e.g. because the receiving unit notes that a transmission unit is missing or that a transmission unit was received with too many errors. The request for a retransmission can be for example the selective ARQ mechanism proposed in the above mentioned amendment 802.16a.

The transmission unit of the invention can be in particular a MAC SDU transmitted in a MAC PDU without packing, a MAC SDU fragment transmitted in a MAC PDU without packing, a MAC SDU transmitted in a MAC PDU with packing, or a MAC SDU fragment transmitted in a MAC PDU with packing.

Preferably, fragmentation information is included in a subheader of each fragment that is to be transmitted. For wireless access systems that are based on the IEEE standard 802.16, this subheader has preferably an ARQ subheader format that consists of the fragmentation or packing subheader defined in this standard and of an additional part. The additional part may comprise for example a field extending the fragmentation sequence number (FSN) field present in the 802.16 Fragmentation Subheader and Packing Subheader, an FSN′ field replicating the FSN field of the respective first transmission unit, an FC′ field replicating the fragmentation control (FC) field in the respective first transmission unit, and a transmission unit sequence number TSN field.

The fields employed for a fragmentation control FC, FC′ preferably comprise 2 bits. The values assigned to the fragmentation control fields FC and FC′ may correspond for example to the values defined in the above mentioned IEEE standard 802.16. In this standard, a value of 00 is used for transmission units that are not fragmented, a value of 01 for a respective last fragment, a value of 10 for a respective first fragment, and a value of 11 for each middle fragment.

The fields employed for a fragmentation sequence number FSN, FSN′ preferably comprise 5 bits. The fields for the transmission sequence number TSN preferably comprise 7 bits.

It is to be noted that the lengths of the fields and the codings in the fragmentation control fields can be selected differently. However, these lengths and codings ensure that the method and the system according to the invention comply with the definitions of the IEEE standard 802.16.

The invention can be employed in particular, though not exclusively, in wireless local area networks (LAN) or metropolitan area networks (MAN).

The invention is moreover applicable for example in point-to-multipoint wireless broadband access networks and in point-to-point wireless broadband access networks, but equally in other system.

The invention can further be employed in particular, though not exclusively, in systems in which the transmission capacity may change due to an adaptive modulation which is applied to signals that are to be transmitted.

### BRIEF DESCRIPTION OF THE FIGURES

In the following, the invention is explained in more detail with reference to drawings, of which

FIG. 1 illustrates an embodiment of the method of the invention in a first situation; and

FIG. 2 illustrates an embodiment of the method of the invention in a second situation.

### DETAILED DESCRIPTION OF THE INVENTION

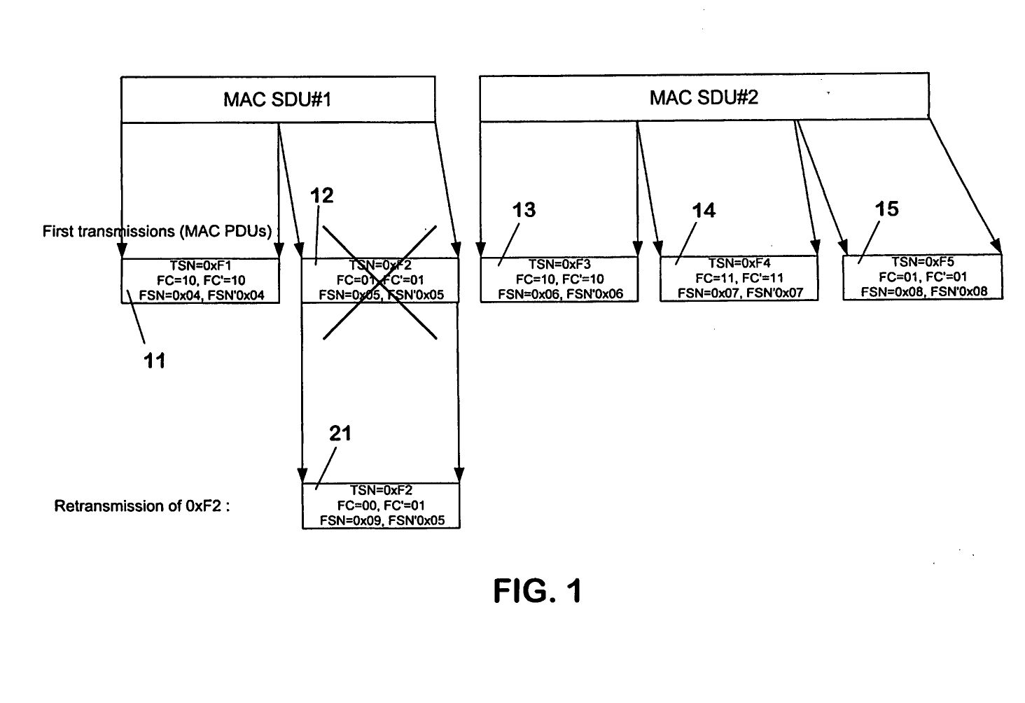

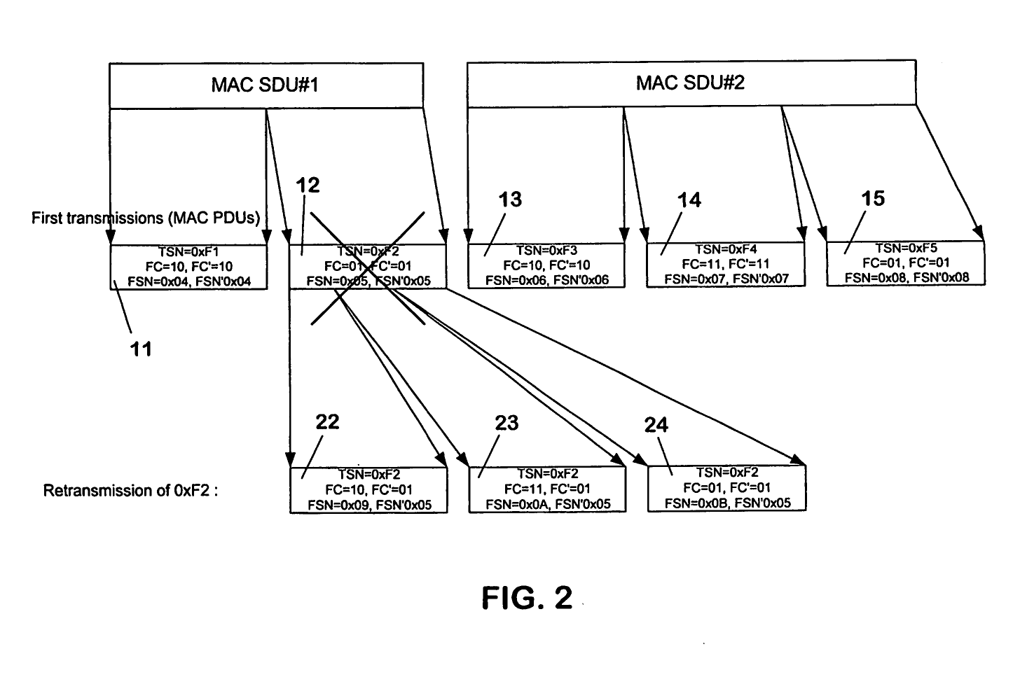

FIG. 1 and FIG. 2 illustrate transmissions and retransmissions of transmitting units in a broadband wireless access system according to the invention. The wireless access system employs fragmentation and an adaptive modulation for transmissions from a base station of a network of the system to a subscriber station of the system.

FIG. 1 depicts in a first row two MAC SDUs #1 and #2 which are to be transmitted by a base station via the air interface to a subscriber station. Both MAC SDUs are fragmented for a first transmission into MAC PDUs 11-15, which are depicted in a second row of FIG. 1. The first MAC SDU #1 is fragmented into two MAC PDUs 11, 12 as indicated by arrows between the first and the second row. The second MAC SDU #2 is fragmented into three MAC PDUs 13-15, which is equally indicated by arrows.

The number of fragments into which the MAC SDUs are fragmented depends on the size of the respective MAC SDU and on the size of the available MAC PDUs. In case of good conditions, a modulation is selected that results in larger MAC PDUs and that thus requires less fragments than a modulation employed for bad conditions.

Each of the MAC PDUs 11-15 comprises a subheader with five fields containing fragmentation information.

The first field in each subheader is a TSN field of 7 bits, which is employed for identifying the respective MAC PDU. The second field is an FC field of 2 bits indicating for the current transmission the position of the respective PDU among the PDUs comprising the fragments of a single MAC SDU. The third field is an FC1 field of 2 bits indicating the position of the PDU containing the same data as the PDU in a first transmission. The fourth field is an FSN field of 5 bits containing a fragmentation sequence number for the respective PDU for the current transmission. The fifth field, finally, is an FSN′ field of 5 bits containing a fragmentation sequence number for the PDU containing the same data as the PDU in a first transmission. The values for the fields for the current transmission are selected as specified in the above mentioned standard 802.16.

The first MAC PDU 11 for the first MAC SDU #1 is assigned a TSN of 0xF1, and an FC of 10, since this MAC PDU 11 is the first fragment of the first MAC SDU #1.

The second MAC PDU 12 for the first MAC SDU #1 is assigned a TSN of 0xF2, and an FC of 01, since this MAC PDU 12 is the last fragment of the first MAC SDU #1.

The first MAC PDU 13 for the second MAC SDU #2 is assigned a TSN of 0xF3, and an FC of 10, since this MAC PDU 13 is the first fragment of the second MAC SDU #2.

The second MAC PDU 14 for the second MAC SDU #2 is assigned a TSN of 0xF4, and an FC of 11, since this MAC PDU 14 is a middle fragment of the second MAC SDU #2.

The third MAC PDU 15 of the second MAC SDU #2 is assigned a TSN of 0xF5, and an FC of 01, since this MAC PDU 15 is the last fragment of the second MAC SDU #2.

The respective value in the FC′ fields is identical to the respective value in the FC fields for each of the MAC PDUs 11-15, since the transmission of the MAC PDUs 11-15 in the second row of FIG. 1 constitutes at the same time the first transmission. For the same reason, the respective value in the FSN′ fields is identical for each of the MAC PDUs 11-15 to the respective value in the FSN fields.

The assembled MAC PDUs 11-15 are transmitted by the base station via the air interface to the subscriber station. During the transmission, the second MAC PDU 12 of the first MAC SDU #1, i.e. fragment 0xF2, is lost. This is reported by the subscriber station to the network in an ARQ feedback message. The lost fragment 12 thus has to be retransmitted. In FIG. 1, MAC PDU 12 of the second row is crossed out in order to indicate the loss during the first transmission.

When a transmission unit is retransmitted, a copy of the original fragmentation control information and of the original fragmentation number is transmitted along with the transmission unit itself. The transmission unit that is to be retransmitted is treated like a new MAC SDU called retransmission SDU and is inserted at an appropriate position into the queue of MAC SDUs that are to be transmitted. The retransmission SDU undergoes the standard fragmentation process if necessary and obeys the same rules for setting the FC and FSN field values as an SDU which is transmitted for the first time.

In the example of FIG. 1, the applied modulation is not changed between the first transmission and the retransmission and the transmission capacity on the air interface stays the same. Therefore, the retransmission can be carried out without refragmentation. This means that the MAC PDU 12 with the TSN value of 0xF2 is transmitted again as a single fragment 21, which fragment 21 is depicted in a third row of FIG. 1. The relation of this fragment 21 to the second MAC PDU 12 of the first MAC SDU #1 is indicated in FIG. 1 by arrows. The values in some of the fields in the subheader of the fragment 21 are changed for retransmission, however, in order to enable the subscriber station to make use of the received, retransmitted fragment 21.

The TSN field in the subheader of the fragment 21 is provided with the same value 0xF2 as before, since this field identifies the lost MAC PDU 12. Also the fields FC1 and FSN′ contain the same values as before, these field containing the information about the lost transmission. The three fields TSN, FC′ and FSN′ enable the subscriber station to relate the retransmitted fragment 21 to the lost MAC PDU 12.

The value of the FC field, in contrast, is changed to 00, since the retransmitted PDU 12 is not fragmented further, fragment 21 thus constituting the only fragment. In addition, the value of the FSN field is incremented according to the conventional rules to 0x09, the last transmitted MAC PDU 15 of the first transmission having been assigned the value 0x0B.

FIG. 2 illustrates the retransmission for a different situation. The retransmission is based on the same embodiment of the method according to the invention as in FIG. 1.

Again, two MAC SDUs #1 and #2 are to be transmitted by a base station via the air interface to a subscriber station. The first fragmentation of the MAC SDUs into MAC PDUs 11-15 corresponds exactly to the first fragmentation in the example of FIG. 1. This is depicted in FIG. 2 by MAC SDUs and MAC PDUs in a first and a second row which are identical to the first and the second row of FIG. 1. Again, the second MAC PDU 12 of the first MAC SDU #1 is lost during transmission, which is reported to the network by an ARQ feedback message of the subscriber substation.

In contrast to the first example, the employed modulation is changed after the first transmission to be more robust. With the new modulation, the content of the second MAC PDU 12 of the first MAC SDU #1 can no longer be transmitted in a single PDU. Therefore, the second MAC PDU 12 has to be rearranged for retransmission.

The MAC PDU 12 with the TSN value 0xF2 is refragmented for retransmission into three new fragments 22-24, which are depicted in the third row of FIG. 2. Arrows relate the new fragments 22-24 to the lost MAC PDU 12 of the second row.

The respective TSN field of the three fragments 22-24 contains again the same value 0xF2, which identifies the lost MAC PDU 12 that has to be retransmitted. Also the fields FC′ and FSN′ contain the same values as before, since these fields contain further information about the lost MAC PDU 12.

The FC and FSN fields in the retransmitted fragments are set according to the normal rules. Therefore, the first fragment 22 is provided with a value of 10, the second fragment 23 with a value of 11 and the third fragment 24 with a value of 01 for the respective FC field. Further, the first fragment 22 is provided with a value of 0x09, the second fragment 23 with a value of 0x0A and the third fragment 24 with a value of 0x0B for the respective FSN field.

The refragmentation mechanism of the invention thus makes it possible to rebuild and reorder fragments in retransmission.

It is to be noted that the described embodiment of the invention constitutes only an example that may be varied in any suitable way.

1. Method for retransmitting a transmission unit (12) via an air interface in a wireless access system employing fragmentation for transmissions, wherein the available transmission capacity on said air interface is variable, wherein said transmission unit (12) was transmitted a first time together with fragmentation information (TSN,FC′,FSN′), and wherein said transmission unit (12) is retransmitted after a refragmentation with information (FC,FSN) on said refragmentation and with at least some of said fragmentation information (TSN,FC′,FSN′) that was transmitted before with said transmission unit (12) in said first transmission.

2. Method according to claim 1, wherein said fragmentation information on a fragmentation for a first transmission comprises at least one of a fragmentation control (FC′), a fragmentation sequence number (FSN′) and a transmission unit sequence number (TSN).

3. Method according to claim 1, wherein said refragmentation information comprises at least one of a fragmentation control (FC) and a fragmentation sequence number (FSN).

4. Method according to claim 1, wherein each fragment (21,22-24) of a refragmented transmission unit (12) is provided with a subheader comprising for the fragmentation and refragmentation information:
a field for a fragmentation sequence number (FSN′) assigned to said transmission unit (12) in the first transmission;
a field for a fragmentation sequence number (FSN) assigned to said fragment (21,22-24) of said transmission unit (12) for the retransmission;
a field for a fragmentation control (FC′) assigned to said transmission unit (12) in the first transmission;
a field for a fragmentation control (FC) assigned to said fragment (21,22-24) of said transmission unit (12) for the retransmission; and
a field for a transmission unit sequence number (TSN) assigned to said transmission unit (12) in the first transmission.

5. Method according to claim 4, wherein said fields for a fragmentation sequence number (FSN,FSN′) are fields of 5 bits, wherein said fields for a fragmentation control (FC,FC′) are fields of 2 bits, and wherein said field for a transmission unit sequence number (TSN) is a field of 7 bits.

6. Method according to claim 1, wherein each transmission unit (12) transmitted a first time and each fragment (21,22-24) of a transmission unit (12) refragmented for retransmission is provided with a subheader comprising the same dedicated fields (TSN,FC,FC′,FSN,FSN′) for fragmentation information.

7. Method according to claim 1, wherein said transmission unit (12) is one of:
a MAC (medium access control) SDU (service data unit) transmitted in a MAC PDU (protocol data unit) without packing;
a MAC SDU fragment transmitted in a MAC PDU without packing;
a MAC SDU transmitted in a MAC PDU with packing; and
a MAC SDU fragment transmitted in a MAC PDU with packing.

8. Method according to claim 1, wherein said transmission unit (12) is retransmitted upon a request by a receiving unit of said wireless access system to which said transmission unit (12) was to be transmitted.

9. Transmitting unit for a wireless access system comprising means for transmitting transmission units (11-15) and for retransmitting transmission units (12) according to claim 1.

10. Transmitting unit according to claim 9, wherein said transmitting unit is part of a first transceiver device, and wherein said transmitting unit is transmitting transmission units (11-15) to a receiving unit which is part of a second transceiver device.

11. Transmitting unit according to claim 9, comprising:
means for fragmenting each data unit (MAC SDU#1, MAC SDU#2) that is to be transmitted via an air interface into at least one transmission unit (11-15) and for providing each transmission unit (11-15) with corresponding fragmentation information (TSN,FC′,FSN′);
means for transmitting transmission units (11-15) to a receiving unit via said air interface;
means for receiving a retransmission request by a receiving unit requesting that a transmission unit (12) is to be retransmitted; and
means for refragmenting a transmission unit (12) for which a retransmission was requested by a receiving unit, and for providing said transmission unit (12) for retransmission with information (FC,FSN) on said refragmentation and with at least some of said fragmentation information (TSN,FC′,FSN′) provided to said transmission unit (12) for a first transmission.

12. Wireless access system comprising a transmitting unit according to claim 9 and a receiving unit comprising means for receiving transmission units transmitted by said transmitting unit and means for requesting a retransmission of transmission units (12) if required.
